(19) United States
(12) Patent Application Publication
(10) Pub. No.: US 2018/0222115 A1
(43) Pub. Date: Aug. 9, 2018

(54) SHAPING APPARATUS AND SHAPING METHOD

(71) Applicant: CANON KABUSHIKI KAISHA, Tokyo (JP)

(72) Inventors: Itaru Watanabe, Yokohama-shi (JP); Toshihiko Miyazaki, Tachikawa-shi (JP)

(21) Appl. No.: 15/748,401

(22) PCT Filed: Aug. 25, 2016
(86) PCT No.: PCT/JP2016/003879

§ 371 Date: Jan. 29, 2018

(30) Foreign Application Priority Data
Aug. 31, 2015 (JP) 2015-171072
Aug. 31, 2015 (JP) 2015-171199
Aug. 23, 2016 (JP) 2016-162816

(51) Int. Cl. B29C 64/188; B29C 64/205; B29C 64/393; B29C 64/295; B29C 64/25; B29C 64/245; B33Y 10/00; B33Y 30/00; B33Y 40/00; B33Y 50/02

(52) U.S. Cl. CPC B29C 64/188; B29C 64/205; B29C 64/393; B29C 64/295; B29C 64/25; B29K 2101/12; B33Y 10/00; B33Y 30/00; B33Y 40/00; B33Y 50/02; B29C 64/245

(57) ABSTRACT

A shaping apparatus includes a first moving unit that moves a base member; a shaping unit that performs a shaping operation of stacking the shaping material on a stacking surface of the base member, thereby shaping a shaping object; a cooling unit that performs a cooling operation of cooling the shaping object shaped on the stacking surface of the base member; and a control unit, wherein the control unit implements control such that the first moving unit moves the base member, on which the shaping object has been shaped, to the cooling unit and a subsequent base member is inserted into the shaping unit when the shaping operation ends, and such that the shaping operation of the shaping unit and the cooling operation of the cooling unit are executed in parallel.

### TECHNICAL FIELD

The present invention relates to a shaping apparatus and a shaping method.

### BACKGROUND ART

Shaping apparatuses which form a three-dimensional shaping object by stacking a large number of layers are drawing attention. A shaping technique of this type is referred to as additive manufacturing (AM), a three-dimensional printer, rapid prototyping (RP), and will be referred to as an AM technique in the following description.

More specifically, the AM technique is a technique of converting three-dimensional shape data of a shaping target object to shaping slice data, forming an image formed of a shaping material for each layer according to the slice data of each layer, and stacking the images sequentially to shape a shaping object.

Since the AM technique is a technique which does not require a mold and can shape a complex shape, the AM technique is used for fabricating various components by taking advantage of the convenience and user-friendliness. For example, the AM technique is used for manufacturing a prototype of a component for examining the quality of an operation and a shape of the component. Moreover, the AM technique is used for manufacturing components of a welfare apparatus such as a hearing aid which is a single item or a small lot product, a shaping object (a component for orthodontic treatment, an artificial tooth, a crown, or the like) for personal dental equipment, and an aircraft part. Moreover, since the AM technique enables manufacturing of complex components which cannot be manufactured using a mold and manufacturing of sophisticated design shapes which incur a lot of time and effort, the AM technique is used for manufacturing components and shaping objects which are difficult to manufacture in the conventional processing method and manufacturing accessories having sophisticated design.

However, since these AM techniques are methods of stacking a shaping material partially, the AM techniques have a problem that it takes a considerable amount of time to manufacture one shaping object as compared to the conventional method of producing a large number of shaping objects having the same shape from the perspective of productivity. PTL 1 discloses a method that solves this problem.

### CITATION LIST

### Patent Literature

[PTL 1]

Japanese Patent Application Laid-open No. 2003-53849

### SUMMARY OF INVENTION

### Technical Problem

As in PTL 1, according to a shaping method of melting a formed shaping material image by heating and stacking the melted shaping material image, the time required for a shaping apparatus to shape one shaping object is shortened remarkably as compared to other shaping methods.

Even if the processing speed is accelerated, the speed is not accelerated to such a level as to complete shaping in several minutes, and in many cases, it takes several hours to shape one shaping object although it depends on the size of the shaping object. Thus, when a plurality of shaping objects are manufactured, it is desired to shorten a total tact time including the time required for preparing apparatuses, preparation for a subsequent shaping operation, and the like as well as a shaping time.

In a method of melting a shaping material image by heating and stacking the melted shaping material image, it is necessary to suppress a difference in thermal expansion between a shaping object on a stage and a layer newly stacked on the shaping object during shaping. In this case, it is important to suppress a temperature distribution, during lowering of temperature, in a shaping object after the shaping material image is stacked. Moreover, it is necessary to slowly cool the shaping object even after a shaping operation ends. Thus, when a shaping object having high accuracy is manufactured, it takes several hours of slow-cooling time as well as the shaping time, and the slow-cooling time results in downtime.

With the foregoing in view, an object of the present invention is to shorten the time required for continuously shaping a plurality of shaping objects with high accuracy.

### Solution to Problem

A first aspect of the present invention resides in a shaping apparatus, comprising: a first moving unit that moves a base member; a shaping unit that performs a shaping operation of disposing, heating, and melting a shaping material, based on slice data, and stacking the shaping material on a stacking surface of the base member, thereby shaping a shaping object; a cooling unit that performs a cooling operation of cooling the shaping object shaped on the stacking surface of the base member; and a control unit that controls the shaping operation, the cooling operation, and moving operation for the base member, wherein the control unit implements control such that the first moving unit moves the base member, on which the shaping object has been shaped, to the cooling unit and a subsequent base member is inserted into the shaping unit when the shaping operation ends, and such that the shaping operation of the shaping unit and the cooling operation of the cooling unit are executed in parallel.

A second aspect of the present invention resides in a shaping method of fabricating a three-dimensional shaping object, comprising: a shaping step of disposing, heating, and melting a shaping material, based on slice data, and stacking the shaping material on a base member, thereby shaping a shaping object; and a cooling step of cooling the shaping object shaped on the base member, wherein when a shaping operation of shaping a subsequent shaping object is performed subsequently to a shaping operation of shaping a preceding shaping object, the cooling step performed on the preceding shaping object and the shaping step performed on the subsequent shaping object are executed in parallel.

### Advantageous Effects of Invention

According to the present invention, it is possible to shorten the time required for continuously shaping a plurality of shaping objects with high accuracy.

Further features of the present invention will become apparent from the following description of exemplary embodiments with reference to the attached drawings.

### BRIEF DESCRIPTION OF DRAWINGS

FIG. 1 is a cross-sectional view illustrating a schematic configuration of a shaping apparatus according to Embodiment 1.

FIG. 2 is a cross-sectional view illustrating a schematic configuration of a shaping apparatus according to Embodiment 2.

FIG. 3 is a cross-sectional view illustrating a schematic configuration of a shaping apparatus according to Embodiment 3.

FIGS. 4A and 4B are schematic diagrams for describing a configuration of a base member according to Embodiment 4.

FIG. 5 is a top view for describing movement of a base member of a shaping apparatus according to Embodiment 4.

FIGS. 6A to 6H are schematic diagrams for describing configurations of a first moving section and a second moving section according to Embodiment 4.

FIGS. 7A to 7C are side views for describing movement of a plate 5 of a shaping apparatus according to Embodiment 4.

FIGS. 8A and 8B are schematic diagrams for describing a configuration of a base member of Embodiment 5.

FIG. 9 is a schematic diagram for describing a configuration of a fixing unit according to Embodiment 5.

### DESCRIPTION OF EMBODIMENTS

The present invention relates to a shaping apparatus and a shaping method for fabricating a three-dimensional object (solid object) by stacking a material layer formed of a shaping material.

As the shaping material, it is possible to select various materials in accordance with the use, function, and purpose of a solid object to be fabricated. In the present specification, a material constituting a three-dimensional object as a shaping target is referred to as “a build material”, and a portion formed of the build material is referred to as a build body. A material constituting a support body for supporting the build body in the process of fabrication (e.g., a pillar supporting an overhang portion from below) is referred to as “a support material”. In addition, in the case where it is not necessary to distinguish between them, a term “shaping material” is simply used. As the build material, it is possible to use thermoplastic resins such as, e.g., polyethylene (PE), polypropylene (PP), ABS, and polystyrene (PS). Further, as the support material, in order to facilitate removal from the build body, it is possible to use a material having thermoplasticity and water solubility preferably. Examples of the support material include carbohydrate, polylactic acid (PLA), polyvinyl alcohol (PVA), and polyethylene glycol (PEG).

In addition, in the present specification, digital data obtained by slicing three-dimensional shape data of a solid model as the shaping target into several layers along a stacking direction is referred to as “slice data”. A layer formed of the shaping material based on the slice data is referred to as “a material layer” or “a material image”. Further, a target solid model that is to be fabricated by using the shaping apparatus (i.e., a three-dimensional object represented by three-dimensional shape data given to the shaping apparatus) is referred to as “a shaping target object”, and a three-dimensional object (solid object) fabricated (outputted) by the shaping apparatus is referred to as “a shaping object”. In the case of the shaping of a three-dimensional object needing the support material, the shaping object includes the build body and the support body. And the build body, that is, the shaping target object is acquired by removing the support body from the shaping object.

### Embodiment 1

Hereinafter, Embodiment 1 will be described.

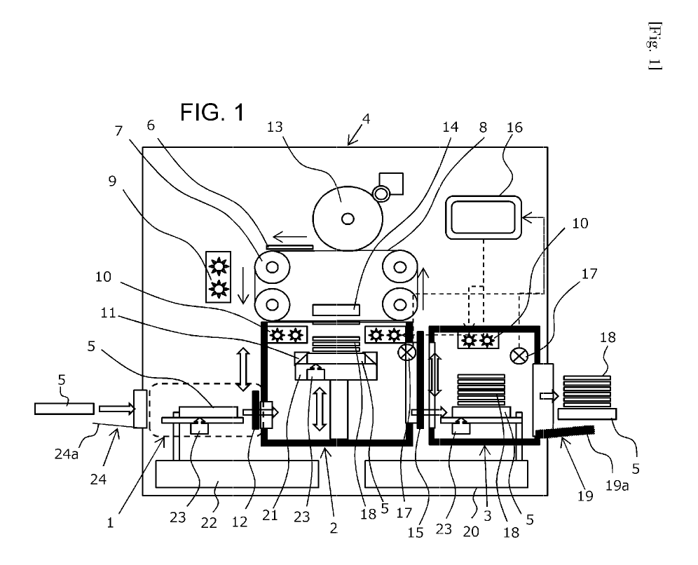

FIG. 1 is a diagram which best shows the characteristics of the present embodiment. In FIG. 1, reference numeral 4 indicates a shaping apparatus, and a line illustrated in the drawing illustrates the boundary—a contour line—between the shaping apparatus and the external space.

The shaping apparatus (hereinafter referred to as an apparatus) 4 of the present embodiment mainly includes functional units including a standby section 1 in which a base member (hereinafter referred to as a plate) 5 waits, a shaping unit 2 that shapes a shaping object on an upper surface (on the base member) of the plate 5, and a cooling unit 3 that cools the shaping object shaped on the plate 5. In the apparatus 4 of the present embodiment, the plate 5 is automatically moved from the standby section 1 to the shaping unit 2, and the plate 5 on which the shaping object has been shaped by the shaping unit 2 is automatically moved from the shaping unit 2 to the cooling unit 3. These moving operations are executed independently. In particular, in the apparatus 4 of the present embodiment, when a plurality of shaping objects are shaped continuously, a cooling operation by the cooling unit 3 performed on a preceding shaping object and a shaping operation by the shaping unit 2 performed on a subsequent shaping object can be executed in parallel. The movement of the plate 5, the cooling operation, and the shaping operation are controlled by a control unit 16. Hereinafter, the operation of each process will be described.

First, the standby section 1 will be described.

The standby section 1 is provided inside the apparatus 4 so that the plate 5 before a shaping object is shaped by the shaping unit 2 waits in the standby section 1. The plate 5 is inserted into the standby section 1 by a plate inserting mechanism 24. A plate inserting mechanism 24 of the present embodiment includes a door 24a formed in the apparatus 4 and an insertion groove (not illustrated). When the plate 5 is inserted, the door 24a is open to push the plate 5 along the insertion groove of the plate inserting mechanism 24 whereby the plate 5 is positioned by a positioning unit 23. In this manner, the plate 5 is inserted into the apparatus 4. As a result, the plate 5 is positioned in the standby section 1. At this position, the plate 5 waits until the shaping operation starts.

Here, the plate inserting mechanism 24 is not limited to the above-described configuration of the present embodiment and the following configuration can be ideally employed. For example, a mount for mounting the plate 5 may be unloaded from the apparatus 4 along a slide rail. Alternatively, an insertion box like an insertion cassette on which recording materials are stacked in a printer may be unloaded from the apparatus 4.

Next, the shaping unit 2 will be described. The shaping unit 2 has a stacking stage 21 configured to be movable in an up-down direction, and is configured as a space (heat-insulating chamber) which is surrounded by a heat-insulating material and is approximately closed. The stacking stage 21 is configured such that the plate 5 can be placed on an upper surface thereof. A heating unit 10 for increasing the temperature of an inner space (the inside of the heat-insulating chamber) in relation to the outside temperature and a temperature measurement unit 17 for acquiring the temperature of the inner space are provided in the shaping unit 2.

Upon receiving a shaping instruction, first, the apparatus 4 increases the temperature inside the shaping unit 2 to a target temperature near a load deflection temperature of the shaping material with the aid of the heating unit 10. Although the target temperature depends on a heat storage state of a shaping object 18 during stacking, the target temperature is set with the aim to suppress deformation due to a difference in thermal expansion of the shaping object 18, resulting from a temperature distribution difference as much as possible while maintaining the shape of the shaping object 18. For example, when the load deflection temperature of the shaping material is 80° C., a lower temperature than that, e.g., at approximately 70° C., is set to the target temperature. When the load deflection temperature is T° C., the target temperature near the load deflection temperature is preferably determined in a temperature range of equal to or higher than (T−20)° C. and lower than T ° C.

When the temperature measurement unit 17 measures that the temperature inside the shaping unit 2 has increased to the target temperature, the control unit 16 drives a first moving section (moving unit) 22 so that the plate 5 waiting in the standby section 1 is moved to the shaping unit 2. Here, an opening and closing door 12 configured as a heat-insulating wall is provided between the shaping unit 2 and the standby section 1 so as to be closed so that the shaping unit 2 and the standby section 1 can communicate with each other. The opening and closing door 12 may be configured to be open with its own driving force according to the position of the plate 5 moving with the aid of the first moving section 22. Alternatively, the opening and closing door 12 may be open by pushing back the portion closed by the elastic force of spring with the aid of the driving force of the first moving section 22.

First, the plate 5 having moved to the shaping unit 2 is positioned on a fixing and releasing mechanism 11 being in a released state, on the stacking stage 21. After that, the plate 5 is positioned by a positioning unit 23 and fixed to the fixing and releasing mechanism 11 with the aid of the vertical driving force of the stacking stage 21 and the like. During shaping, heat and pressure are applied to the plate 5. In this case, steps are formed in the shaping object 18 if the plate 5 is shifted on the stacking stage 21. Thus, in the present embodiment, the plate 5 is positioned and fixed onto the stacking stage 21.

A material image 6 formed in an image forming process (described later) is stacked on the plate 5 which is integrally fixed to the stacking stage 21 by the fixing and releasing mechanism 11 and the shaping object 18 is shaped.

Here, the image forming process will be described.

When the apparatus 4 receives slice data from an external data processing device (not illustrated), the image forming unit 13 disposes a shaping material according to the slice data to form a material image 6. The image forming unit may employ an electrophotographic method, an inkjet method, or the like.

The material image 6 formed by the image forming unit 13 is transferred to a transfer member 8 which is a belt-shaped conveying member and is conveyed up to a stacking unit in a direction indicated by an arrow in the drawing by a driving roller 7. In the course of being conveyed to the stacking unit, the material image 6 is heated and melted by the heating unit 9, and the shaping material which is a powder form is changed to a material layer which is integrated in a sheet form. Here, the stacking unit includes a stacking stage 21, a transfer member 8, and an abutting portion 14 disposed on an inner circumference side of the transfer member 8 so as to face the stacking stage 21.

When the material layer transferred to the transfer member 8 moves to the stacking unit, the stacking stage 21 is moved upward. As a result, the material layer which has been transferred to the transfer member 8 and is heated and melted in a sheet form is sandwiched, together with the transfer member 8, between the abutting portion 14 and an upper surface of the shaping object 18 on the plate 5 fixed to the stacking stage 21. In this case, the material layer is transferred from the transfer member 8 to the upper surface of the shaping object 18 on the plate 5 and is stacked. After that, the stacking stage 21 is moved downward to stack the material layer conveyed subsequently. This operation is performed repeatedly whereby a shaping object is shaped on the plate 5. In some shaping apparatuses, a material layer is stacked directly on the stacking stage. However, in the apparatus 4 of the present embodiment, the plate 5 that can be conveyed is disposed on the stacking stage and a shaping object is shaped on the plate 5. In the present embodiment, the plate 5 and the shaping object 18 are unloaded in an integrated state when a shaping operation ends.

With the progress of the shaping operation, since the heat during stacking remains in the shaping object 18 being shaped, the temperature inside the shaping unit 2 is decreased gradually in accordance with a shape. In this way, the shaping object 18 can be shaped with high accuracy. The temperature inside the shaping unit 2 can be decreased gradually by the control unit 16 controlling the temperature of the heating unit 10 by referring to the value measured by the temperature measurement unit 17. In this case, the target temperature needs to be controlled so that the maximum value of the temperature of the shaping object 18 being shaped is equal to or lower than the load deflection temperature. Moreover, the target temperature needs to be controlled so as to suppress deformation due to a difference in thermal expansion resulting from a temperature difference between a latest stacked portion and a lowest-temperature portion (an outside portion or a thin portion of a shaping object) of the shaping object 18 being shaped.

When the shaping operation of the shaping unit 2 ends, each plate 5 having the shaping object 18 thereon is moved to the cooling unit 3 adjacent to the shaping unit 2 and a cooling operation is performed.

Next, the cooling unit 3 will be described.

The cooling unit 3 has a heating unit 10 and a temperature measurement unit 17 similarly to the shaping unit 2 and is configured as a space (heat-insulating chamber) that is shielded from the outside space by a heat-insulating material. Moreover, a plate unloading mechanism 19 is provided in the cooling unit 3 so that each plate 5 having the shaping object 18 thereon can be unloaded from the apparatus 4 by the plate unloading mechanism 19. Here, a motor-driven heat-insulating opening and closing door 15 having a heat-insulating structure is provided between the shaping unit 2 and the cooling unit 3. The cooling operation of the cooling unit 3 will be described below.

When it is detected or predicted that the shaping operation of the shaping unit 2 ended, the control unit 16 increases the temperature of the cooling unit 3 up to a target temperature. In this case, the target temperature is set with the aim to avoid the influence of deformation due to a difference in thermal expansion as described in connection with the shaping unit 2. However, when a standby time or the like for the next operation occurs in the shaping unit 2, since the temperature of the shaping object 18 has already started decreasing, it is not necessary to increase the temperature of the cooling unit 3 to be higher than the temperature of the shaping object 18 at that time.

When the temperature measured by the temperature measurement unit 17 of the cooling unit 3 reaches the target temperature, the control unit 16 stops the heating operation of the heating unit 10 and opens the heat-insulating opening and closing door 15. Subsequently, the control unit 16 releases the fixed state of the plate 5 fixed to the stacking stage 21 by the fixing and releasing mechanism 11 and moves the plate 5 on which the shaping object 18 has been shaped on the upper surface thereof from the shaping unit 2 to the cooling unit 3 with the aid of a second moving section 20. The plate 5 pushed into the cooling unit 3 by the second moving section 20 is positioned by the positioning unit 23 provided in the cooling unit 3. After that, the control unit 16 closes the heat-insulating opening and closing door 15 to start cooling the shaping object 18. After that, the cooling operation is performed until the shape of the shaping object 18 is fixed. In this case, the cooling rate (that is, a temperature drop per unit time) may be determined according to the shape of a shaping material or a shaping object so that strain does not occur in the shaping object 18. For example, if shaping objects have the same shape, the lower the thermal conductivity of a shaping material used, the lower is set the cooling rate. If shaping objects use the same shaping material, the smaller the thickness or the size of the shape, the lower is set the cooling rate. The control unit 16 may perform a cooling operation by controlling the temperature of the heating unit 10 at such a cooling rate that a strain does not occur in the shaping object 18 until a temperature region in which the shape of the shaping object 18 is fixed is measured by the temperature measurement unit 17 of the cooling unit 3. The cooling rate during cooling does not need to be constant.

Specifically, when the cooling operation of the cooling unit 3 ends, the plate unloading mechanism 19 is operated to open an unloading door 19a that is openably attached to the cooling unit 3 to unload the plate 5 on which the shaping object 18 has been shaped on the upper surface thereof along an unloading rail. In this case, the control unit 16 may inform an operator by turning on a lamp, displaying a message on a display, or outputting a sound to show that the cooling operation of the cooling unit 3 has ended and a state in which the plate 5 having the shaping object 18 shaped thereon can be unloaded is created.

Hereinabove, the configuration of the apparatus 4 and a series of operations of the apparatus 4 when one shaping object is shaped have been described.

Next, an operation when the apparatus 4 receives a shaping instruction to perform a shaping operation continuously will be described.

When the apparatus 4 receives a shaping instruction to perform a shaping operation continuously, the control unit 16 allows the shaping unit 2 to perform a shaping operation of shaping the next shaping object (hereinafter referred to as a subsequent shaping object) subsequently to a shaping operation of shaping a preceding shaping object (hereinafter referred to as a preceding shaping object). The present embodiment is characterized in that, in such a case, the control unit 16 controls the cooling unit 3 and the shaping unit 2 to execute a cooling operation performed on a preceding shaping object and a shaping operation performed on a subsequent shaping object in parallel. Hereinafter, this parallel processing will be described in more detail.

First, the process in which the shaping unit 2 performs a shaping operation so that the shaping object 18 is shaped on the plate 5 is the same as the above-described process.

Upon detecting the end of a shaping operation on a preceding shaping object or the approach thereto, the control unit 16 starts warming the cooling unit 3.

When conditions that a subsequent shaping instruction has been issued, a shaping operation of the shaping unit 2 has ended, and the temperature of the cooling unit 3 has reached a target temperature are satisfied, the control unit 16 opens the heat-insulating opening and closing door 15 and releases the fixed state of the fixing and releasing mechanism 11 of the shaping unit 2.

Subsequently, the control unit 16 moves a first plate 5 (the first in the continuous shaping operation) on which the preceding shaping object has been shaped on the upper surface from the shaping unit 2 to the cooling unit 3 with the aid of the second moving section 20. After that, the control unit 16 closes the heat-insulating opening and closing door 15 and the cooling unit 3 starts cooling the preceding shaping object.

When the cooling unit 3 starts cooling the preceding shaping object, the control unit 16 moves a second plate 5 (the second in the continuous shaping operation) waiting in the standby section 1 to the shaping unit 2 with the aid of the first moving section 22. The timing at which the second plate 5 is placed in the standby section 1 may be determined regardless of the position of the first plate 5 as long as the second plate 5 can be moved to the shaping unit 2 in time.

Here, in the present embodiment, after the plate 5 on which the preceding shaping object has been shaped is moved from the shaping unit 2 to the cooling unit 3 and the cooling unit 3 starts cooling the preceding shaping object, the second plate 5 waiting in the standby section 1 is moved to the shaping unit 2. However, the present invention is not limited to this. The timing at which the second plate 5 waiting in the standby section 1 is positioned in the shaping unit 2 instead of the plate 5 on which the preceding shaping object has been shaped may be set appropriately within a range of timing that causes no problem in management of the temperature inside the shaping unit 2.

A subsequent shaping operation of the shaping unit 2—a shaping operation on a subsequent shaping object which is stacked and shaped on the second plate 5—is performed in the same manner as described above.

As described above, in the present embodiment, when a plurality of shaping objects is shaped continuously, a cooling operation of the cooling unit 3 performed on the preceding shaping object and a shaping operation of the shaping unit 2 performed on the subsequent shaping object can be executed in parallel.

In the conventional shaping apparatus, after a cooling operation of the cooling unit on the preceding shaping object ends and the preceding shaping object is unloaded from the cooling unit, a shaping operation on the subsequent shaping object starts.

In contrast, in the present embodiment, a shaping operation on the subsequent shaping object can be performed during the cooling operation on the preceding shaping object.

Thus, it is possible to shorten the time required for shaping a plurality of shaping objects continuously with high accuracy.

Furthermore, it is possible to secure a sufficient time for the cooling unit 3 cooling the shaping object and a shaping operation can be performed with high accuracy.

Furthermore, in the present embodiment, the second moving section 20 that moves the plate 5 from the shaping unit 2 to the cooling unit 3 and the first moving section 22 that moves the plate 5 from the standby section 1 to the shaping unit 2 are provided so as to be controllable independently by the control unit 16.

Due to this, when a shaping operation on a preceding shaping object ends, the preceding shaping object can be automatically moved to the cooling unit 3 by the second moving section 20. Moreover, the plate 5 for stacking a subsequent shaping object can be automatically moved to the shaping unit 2 from which the preceding shaping object has been removed by the first moving section 22.

Conventionally, since an actual shaping object takes several hours to several tens of hours, the apparatus is often operated in the nighttime. When a shaping operation ends in the nighttime, it is not possible to perform preparations for the next shaping operation, and the nighttime results in downtime until an operator visits the place in the morning. Moreover, since the time elapsed after a shaping operation ends and before the operator visits the place results in downtime without limiting to the nighttime, it is difficult to shorten the shaping time when shaping a plurality of shaping objects. In contrast, although an apparatus having a function of predicting a shaping end time and informing an operator in advance is known, it is not possible to avoid the downtime when a shaping operation ends in the nighttime.

In contrast, according to the present embodiment, when a plate used for a subsequent shaping operation is placed in the standby section, even if an operator is not present for example in the nighttime, it is possible to perform a shaping operation on a subsequent shaping object automatically subsequently to a preceding shaping object after a shaping operation on the preceding shaping object ends.

Moreover, when the plate 5 is inserted into the standby section 1, the subsequent shaping operation on a shaping object is automatically performed to create a state in which acquisition of the shaping object is possible. Thus, any operator can use the shaping apparatus without requiring the skill of the operator.

In the present embodiment, the control unit 16 drives the moving section to automatically move the plate based on the measurement results obtained by the temperature measurement unit. However, the present invention is not limited to this. For example, an operator may start driving of the moving section based on the measurement results obtained by the temperature measurement unit. The above-described advantages can be obtained as long as a cooling operation performed on a preceding shaping object and a shaping operation performed on a subsequent shaping object are executed in parallel.

### Embodiment 2

Hereinafter, Embodiment 2 will be described.

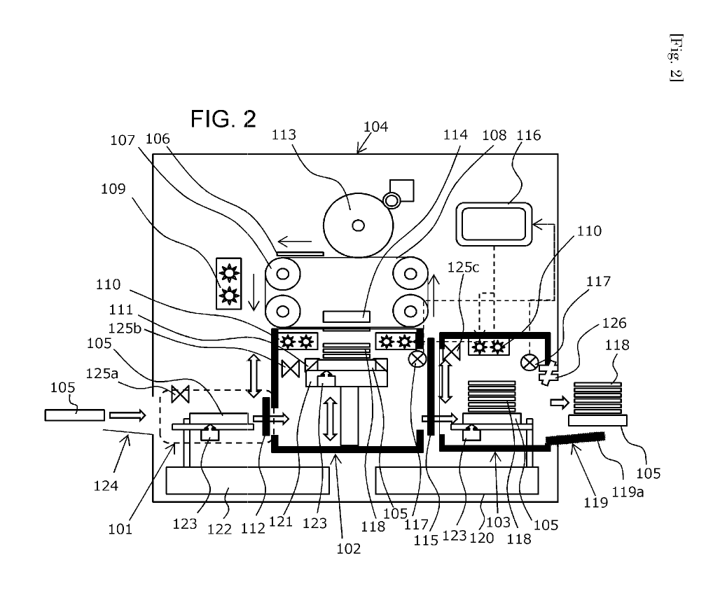

FIG. 2 is a diagram which best shows the characteristics of the present embodiment. In FIG. 2, constituent elements denoted by reference numerals 101 to 123 have the same functions as the constituent elements denoted by reference numerals 1 to 23 in Embodiment 1, and the description thereof will not be provided.

In the shaping apparatus of the present embodiment, in addition to the constituent elements of the apparatus 4 of Embodiment 1, plate present detecting units 125a to 125c for detecting the presence of a plate and a lock mechanism 126 as a fixing mechanism for fixing an unloading door 119a in a closed state are provided. In the present embodiment, plate present detecting units 125 are provided in a standby section 101, a shaping unit 102, and a cooling unit 103, respectively, and the lock mechanism 126 is provided in the cooling unit 103.

Hereinafter, an operation portion different from that of Embodiment 1, within the operation when an apparatus 104 receives a shaping instruction continuously according to the present embodiment will be described.

The control unit 16 of Embodiment 1 starts warming the cooling unit 3 upon detecting the end of a shaping operation on a preceding shaping object or the approach thereto. In contrast, a control unit 116 of the present embodiment starts warming the cooling unit 103 when the following conditions are satisfied. The conditions include that the plate present detecting unit 125c in the cooling unit 103 detects that a plate 105 is not present in the cooling unit, in addition to detection of the end of a shaping operation on a preceding shaping object or the approach thereto.

Moreover, the control unit 16 of Embodiment 1 moves the second plate 5 waiting in the standby section 1 to the shaping unit 2 with the aid of the first moving section 22 when a cooling operation on a preceding shaping object starts. In contrast, the control unit 116 of the present embodiment moves the second plate 105 waiting in the standby section 101 to the shaping unit 102 when the following conditions are satisfied. The conditions include that a cooling operation on a preceding shaping object has started and the plate present detecting unit 125a in the standby section 101 has detected that the second plate 105 is present in the standby section.

Here, the control unit 116 of the present embodiment may start warming the cooling unit 103 and perform a continuous shaping operation similarly to Embodiment 1 when the following conditions are satisfied in addition to detection of the end of a shaping operation on a preceding shaping object or the approach thereto. The conditions include that the plate present detecting unit 125c in the cooling unit 103 has detected the absence of the plate 105 and the plate present detecting unit 125a in the standby section 101 has detected the presence of the second plate 105.

Since the apparatus 104 of the present embodiment includes the plate present detecting unit 125, it is possible to avoid various errors. Hereinafter, this feature will be described in further detail.

For example, a case in which the shaping unit 102 has finished a shaping operation on a subsequent shaping object but a preceding shaping object has not been unloaded from the cooling unit 103 may occur. In such a case, if the plate 105 on which the subsequent shaping object has been shaped is moved to the cooling unit 103, the plate 105 may collide with another plate 105 on which the preceding shaping object has been shaped.

In contrast, in the present embodiment, the plate 105 present in the cooling unit 103 can be detected by the plate present detecting unit 125c in the cooling unit 103. As a result, when a preceding shaping object is present in the cooling unit 103, it is possible to prevent the plate 105 on which the subsequent shaping object has been shaped from being moved to the cooling unit 103.

In this case, although the plate 105 on which the subsequent shaping object has been shaped remains in the shaping unit 102 even the shaping operation ends, the cooling operation which is originally performed in the cooling unit 103 may be performed in the shaping unit 102. In this case, even when a subsequent shaping instruction is issued, a subsequent shaping operation does not start but the apparatus 104 enters a standby state. After that, when an operator unloads a preceding shaping object which has been cooled from the cooling unit 103, the plate present detecting unit 125c immediately detects the absence of the plate 105 in the cooling unit 103, and a temperature detecting unit 117 detects the temperature of the shaping unit 102 in which a cooling operation has progressed to some extent. Moreover, a heating unit 110 of the cooling unit 103 controls the temperature of the cooling unit 103 so as to reach the temperature of the shaping unit 102 detected by the temperature detecting unit 117. When the temperature of the cooling unit 103 becomes equal to the temperature of the shaping unit 102, the control unit 116 opens the heat-insulating opening and closing door 115 and moves the plate 105 on which the subsequent shaping object has been shaped by the shaping unit 102 to the cooling unit 103 with the aid of a second moving section 120. The subsequent cooling operation is performed in the same manner as described above.

When a shaping object has such a shape that a subsequent shaping object has a small and thin shape whereas a preceding shaping object has a large shape, the time required for a cooling operation on the preceding shaping object may be longer than the time required for a shaping operation on the subsequent shaping object. In such a case, by allowing a cooling operation on the subsequent shaping object to progress in the shaping unit 102, it is possible to shorten the time required for shaping all of a plurality of shaping objects more accurately.

Moreover, when the plate 105 is moved from the standby section 101 to the shaping unit 102, the plate 105 may be moved to the shaping unit 102 by a first moving section 122 when the plate present detecting unit 125a in the standby section 101 detects the plate 105. In this case, the detection result obtained by the plate present detecting unit 125b in the shaping unit 102, which detects the presence of the plate 105 in the shaping unit may also be used. That is, the plate 105 may be moved to the shaping unit 102 by the first moving section 122 when the plate present detecting unit 125 in the standby section 101 detects the presence of a plate and the plate present detecting unit 125b in the shaping unit 102 detects the absence of the plate.

Moreover, when the plate 105 is not present in the standby section 101, the plate present detecting unit 125a may detect non-mounting of the plate 105 and the apparatus 104 may enter a standby state even when a shaping instruction is issued. In such a case, the control unit 116 may have a notification unit that informs an operator of the fact that a shaping operation cannot start due to non-mounting of the plate 105. In this way, it is possible to urge the operator to insert the plate 105.

After that, when the operator inserts a new plate 105 into the standby section 101, the plate present detecting unit 125a in the standby section 101 detects the plate 105. In this way, as described above, the newly inserted plate 105 is moved to the shaping unit 102 and the shaping unit 102 starts a shaping operation.

Moreover, in the present embodiment, the lock mechanism 126 that fixes the unloading door 119a in a closed state when the temperature of the cooling unit 103 measured by the temperature detecting unit 117 is higher than a set temperature is provided in the cooling unit 103. This lock mechanism 126 prevents the unloading door 119a from being open until the temperature inside the cooling unit 103 gradually decreases to the set temperature. The set temperature is a temperature at which no problem occurs even when an operator touches the plate 105, a shaping object 118, a plate unloading mechanism 119, and the surrounding portions when the operator unloads the plate 105 from the cooling unit 103. In this case, information that it is not possible to acquire the plate 105 may be transmitted to the operator using a notification means such as turning on of a lamp or a message displayed on a display. In this way, it is possible to prevent the operator from touching hot members.

As described above, according to the present embodiment, it is possible to obtain the following advantages in addition to the above-described advantages of Embodiment 1. That is, since the plate present detecting units 125a to 125c are provided, various errors can be avoided. For example, when plates are moved by the moving section, and if a preceding plate is still present in a destination, it is possible to stop a moving operation. Thus, it is possible to provide a shaping apparatus capable of shaping a shaping object more stably.

Moreover, since the lock mechanism 126 is provided, it is possible to prevent an operator from touching hot members when unloading the shaping object. Thus, it is possible to provide a highly safe shaping apparatus.

### Embodiment 3

Hereinafter, Embodiment 3 will be described.

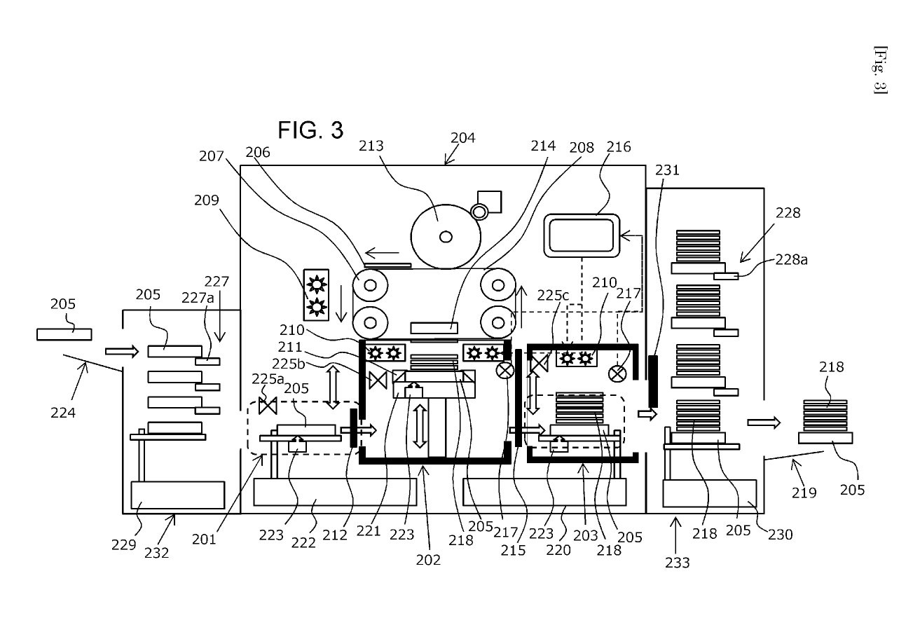

FIG. 3 is a diagram which best shows the characteristics of the present embodiment. In FIG. 3, constituent elements denoted by reference numerals 201 to 218, 220, 221, 222, 223, and 225 have the same functions as the constituent elements denoted by reference numerals 101 to 118, 120, 121, 122, 123, and 125 in Embodiment 2, and the description thereof will not be provided.

The present embodiment is characterized in that a plate supply device (base member supply unit) 232 and a shaping object holding device (shaping object holding unit) 233 are provided outside the apparatus 104 of Embodiment 2 as new constituent elements.

The plate supply device 232 is a device that automates an operation of inserting a plate 205 into a standby section 201 and includes a plate inserting mechanism 224, a holding mechanism 227, and a driving mechanism 229.

Here, the plate inserting mechanism 224 is a mechanism for inserting the plate 205 into the plate supply device 232. Moreover, the holding mechanism 227 is a mechanism for holding a plurality of plates 205 inserted into the plate supply device 232 and a plurality of holding portions 227a that holds the plate 205 is provided. Moreover, the driving mechanism 229 is a mechanism for conveying the plate 205 inside the holding mechanism 227 or conveying the plate 205 from the plate supply device 232 to the standby section 201 of an apparatus 204.

Moreover, the shaping object holding device 233 is a device that automates an operation of acquiring the shaping object 218 on which a cooling unit 203 has finished a cooling operation and includes a plate unloading mechanism 219, a holding mechanism 228, a driving mechanism 230, and a heat-insulating opening and closing door 231. The shaping object holding device 233 has a structure capable of cooling a shaping objects 218 individually. For example, the shaping object holding device 233 may have a structure in which the inner space of the shaping object holding device 233 is partitioned into a plurality of rooms and the temperatures of the respective rooms can be controlled individually to realizing cooling. Alternatively, the shaping object holding device 233 may have a structure in which a temperature gradient is created inside the shaping object holding device 233 and the shaping object 218 unloaded from a shaping unit 202 is moved sequentially from a high-temperature region to a low-temperature region.

Here, the plate unloading mechanism 219 is a mechanism for unloading the plate 205 on which the shaping object 218 has been shaped. Moreover, the holding mechanism 228 is a mechanism for holding a plurality of plates 205 on which the shaping object 218 has been shaped, and a plurality of holding portions 228a that holds the plate 205 is provided. Moreover, the driving mechanism 230 is a mechanism for conveying the plate 205 on which the shaping object 218 has been shaped inside the holding mechanism 228 or conveying the plate 205 on which the shaping object 218 has been shaped from the cooling unit 203 to the shaping object holding device 233.

Moreover, the heat-insulating opening and closing door 231 is a motor-driven door formed of a heat-insulating wall, provided between the cooling unit 203 and the shaping object holding device 233 so as to be closed so that the cooling unit 203 and the shaping object holding device 233 can communicate with each other.

When an operator inserts the plate 205 from the plate inserting mechanism 224 into the plate supply device 232, the control unit 216 operates the driving mechanism 229 inside the plate supply device 232 (that is, moves the driving mechanism 229 in a horizontal direction and a vertical direction). In this way, the plate 205 is conveyed to and held on a vacant holding portion 227a of the holding mechanism 227.

When the standby section 201 is empty, the control unit 216 drives the driving mechanism 229 to move one plate 205 to the standby section 201. The subsequent operation is performed in the same manner as described above.

Moreover, when the cooling unit 203 finishes the cooling operation, the control unit 216 opens the heat-insulating opening and closing door 231 and operates the driving mechanism 230 to move the plate 205 on which the shaping object 218 has been shaped into the shaping object holding device 233.

After that, the control unit 216 operates the driving mechanism 230 (that is, moves the driving mechanism 230 in a horizontal direction and a vertical direction) so that the plate 205 on which the shaping object 218 has been shaped is conveyed to and held on a vacant holding portion 228a of the holding mechanism 228.

The control unit 216 closes the heat-insulating opening and closing door 231 when the plate 205 on which the shaping object 218 has been shaped stops moving.

When the heat-insulating opening and closing door 231 is in a closed state, the plate 205 on which the shaping object 218 has been shaped can be unloaded from the shaping object holding device 233 at any time.

As described above, according to the present embodiment, a number of shaping objects corresponding to the number of plates 205 held on the plate supply device 232 can be automatically shaped continuously. Therefore, it is possible to obtain an advantage that a plurality of shaping objects can be shaped even when an operator is not present for a long period, in addition to the above-described advantages of Embodiment 1.

Here, FIG. 3 illustrates an example in which the plate 205 on which the shaping object 218 has been shaped, held by the holding mechanism 228 in the shaping object holding device 233 is moved up to the plate unloading mechanism 219 by the driving mechanism 230 and is unloaded from the same unloading port. However, the present invention is not limited to this, and the unloading port may be formed for each holding portion 228a so as to correspond to the plurality of holding portions 228a of the holding mechanism 228.

Moreover, in the present embodiment, although the plate supply device 232 and the shaping object holding device 233 are provided outside the apparatus 204, the plate supply device 232 and the shaping object holding device 233 may be integrated into the apparatus 204. In this case, at least one of the plate supply device 232 and the shaping object holding device 233 may be integrated into the apparatus 204. Moreover, the plate supply device 232 and the shaping object holding device 233 may be detachably attached to the apparatus 204. In this case, at least one of the plate supply device 232 and the shaping object holding device 233 may be detachably attached to the apparatus 204.

Moreover, in the present embodiment, although the plate supply device 232 and the shaping object holding device 233 are provided outside the apparatus 204, the present invention is not limited to this and the apparatus 204 may have the functions of the plate supply device 232 and the shaping object holding device 233.

For example, the function of the plate supply device 232 may be provided in the standby section 201 of the apparatus 204. In this case, the standby section 201 may include the respective mechanisms corresponding to the plate inserting mechanism 224, the holding mechanism 227, and the driving mechanism 229.

Moreover, the function of the shaping object holding device 233 may be provided in the cooling unit 203 of the apparatus 204. In this case, the cooling unit 203 may include the plate unloading mechanism 219, the holding mechanism 228, and the driving mechanism 230 in addition to the heat-insulating chamber, and the heat-insulating opening and closing door 231 may be provided between the heat-insulating chamber and the holding mechanism 228.

### Embodiment 4

In the present embodiment, a configuration example of the positioning unit 23 and the fixing and releasing mechanism 11 ideal for moving a shaping plate automatically from the standby section 1 to the shaping unit 2 and from the shaping unit 2 to the cooling unit 3 in the apparatus 4 illustrated in FIG. 1 will be described.

In the following description, a direction parallel to a stacking surface 27 which is a surface of the plate 5 on which the shaping object has been shaped will be referred to as an “in-plane direction”, and a direction orthogonal to the stacking surface will be referred to as an “orthogonal direction” or an “up-down direction”. Moreover, in the orthogonal direction, a direction directed to an upper portion of the drawing sheet of FIG. 1 is defined as an upward direction, and a direction directed to a lower portion of the drawing sheet of FIG. 1 is defined as a downward direction. A direction which is parallel to the stacking surface 27 and in which the standby section 1, the shaping unit 2, and the cooling unit 3 are arranged is defined as an x-direction, and a direction which is parallel to the stacking surface 27 and is vertical to the x-direction is defined as a y-direction.

The positioning unit 23 of the present embodiment positions the plate 5 at a predetermined position by fitting a plurality of pins formed in the stacking stage 21 to a plurality of holes formed in the plate 5. The fixing and releasing mechanism 11 is a fixing unit that enables the relative position between the stacking stage 21 and the plate 5 disposed on the stacking stage 21 to be fixed. The configuration of the positioning unit 23 and the fixing and releasing mechanism 11 will be described later.

During shaping, the position of the plate 5 on the stacking stage 21 may change when heat and pressure are applied to the plate 5 and vibration generated inside the apparatus 4 is applied to the plate 5. In particular, in a configuration in which the plate 5 on which a material layer is stacked is moved, a positional shift of the plate 5 on the stacking stage 21 is likely to occur. When the position of the plate 5 on the stacking stage 21 changes during stacking, since the position in the in-plane direction in which a material layer is stacked is different in respective multilayer images, steps are formed in the shaping object 18.

Thus, in the present embodiment, at least when the shaping unit 2 performs an operation of stacking a material layer, the fixing and releasing mechanism 11 fixes the relative position between the plate 5 and the stacking stage 21 in the in-plane direction and the orthogonal direction. Due to such a configuration, movement in the in-plane direction of the plate 5 occurring when the plate 5 is moved in the orthogonal direction to perform stacking is reduced. As a result, it is possible to reduce the positional shift between the plate 5 and the stacking stage 21 as compared to the conventional technique. As in PTL 1, when positioning is performed using a fitting portion, a positional shift of larger than 100 μm may occur in the in-plane direction of the plate 5. However, according to the present embodiment, it can be expected that the positional shift can be reduced to be 100 μm or smaller. Preferably, the positional shift of the plate 5 is reduced to the thickness of the material layer or smaller. The thickness of the material layer is 10 μm or more and 30 μm or smaller, for example.

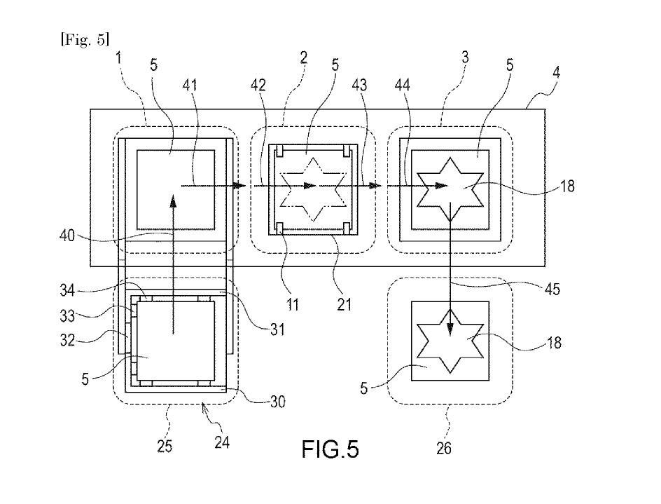

Here, an example of a configuration of an inserting unit that inserts the plate 5 and a configuration of an unloading unit that unloads the plate 5 from the apparatus 4 will be described with reference to FIG. 5. FIG. 5 is a top view for describing movement of the plate 5 in the apparatus 4. In this example, an inserting unit 25 is disposed at a position separated in the y-direction from the standby section 1. Moreover, an unloading unit 26 for unloading the plate 5 from the apparatus 4 is disposed at a position separated in the y-direction from the cooling unit 3.

The plate inserting mechanism 24 includes an accommodation portion 30 for accommodating the plate 5 and an x-direction positioning member 33 and a y-direction positioning member 34 as the positioning unit 28 provided on side surfaces 31 of the accommodation portion 30. The x-direction positioning member 33 and the y-direction positioning member 34 have a tapered shape from the upper side toward the lower side so that, when the plate 5 is set on the accommodation portion 30, the positions of the members are determined in alignment with the outer shape of the plate 5.

The plate inserting mechanism 24 is configured to draw the accommodation portion 30 and move the accommodation portion 30 up to the inserting unit 25. Moreover, the plate inserting mechanism 24 holds the left and right sides of the plate 5, inserts a hand into a notch 32 formed in the accommodation portion 30, and lowers the plate 5 by pressing the plate 5 against the x-direction positioning member 33 and the y-direction positioning member 34 from above to realize positioning. Since positioning is realized when the plate 5 is accommodated in the accommodation portion 30, it is not necessary to adjust the position while the shaping unit 2 is moving after the plate 5 is moved in a direction indicated by arrow 40 and is disposed in the standby section 1.

When preparations for stacking are made after the plate 5 is disposed in the standby section 1, the plate 5 is moved in the direction indicated by arrows 41 and 42 by the first moving section 22 to reach the shaping unit 2. When the plate 5 is moved to the shaping unit 2, another subsequent plate can be inserted. When stacking ends, the plate 5 is moved in the direction indicated by arrows 43 and 44 by the second moving section 20 to reach the cooling unit 3. When the cooling unit 3 finishes cooling and preparations for acquisition are made, the plate 5 is moved in the direction indicated by arrow 45 by the plate unloading mechanism 19 to reach the unloading unit 26. The movement of the plate to the unloading unit 26 may be performed manually and may be performed automatically by the control unit 16.

In this manner, by providing the inserting unit 25 and the unloading unit 26 on the side separated in the y-direction from the standby section 1 or the cooling unit 3, it is possible to decrease the width and the depth of the apparatus 4.

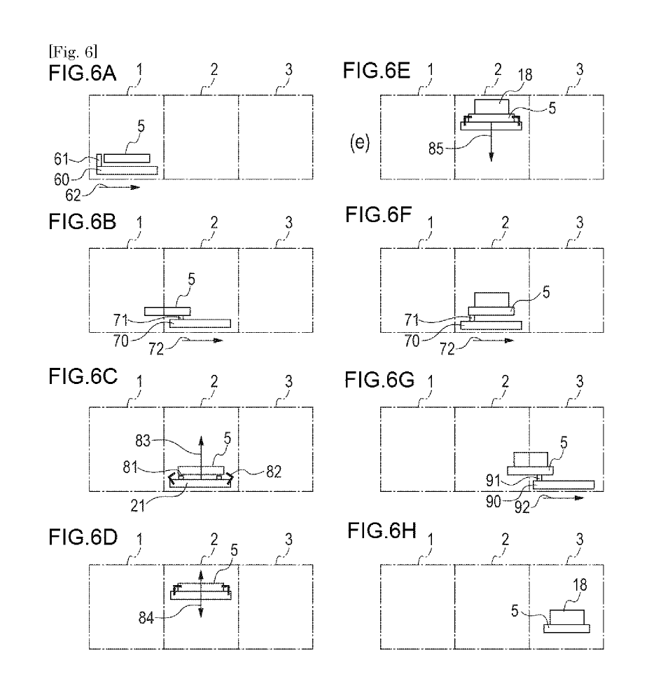

An example of the configuration of the first and second moving sections 22 and 20 will be described with reference to FIGS. 6A to 6H. FIGS. 6A to 6H are schematic diagrams for describing the configuration of the first and second moving sections 22 and 20. The first moving section 22 includes a first driving mechanism 60 and a second driving mechanism 70. The second moving section 20 includes the second driving mechanism 70 and a third driving mechanism 90.

FIG. 6A illustrates a state in which the plate 5 is disposed in the standby section 1. The first driving mechanism 60 moves the plate 5 in the direction indicated by arrow 62 by moving a pin 61 which is in contact with an end surface of the plate 5. The second driving mechanism 70 is disposed in the shaping unit 2 and has a claw 71 that engages with a concave portion formed in an end of a lower surface of the plate 5. As illustrated in FIG. 6B, the plate 5 moved by the first driving mechanism 60 engages with the claw 71 and is conveyed in the direction indicated by arrow 72 by the second driving mechanism 70 and is disposed at a predetermined position in the shaping unit 2 (FIG. 6C). A spring mechanism is provided in the claw 71 so that the claw 71 is disengaged from the concave portion of the plate 5 when conveying of the plate 5 is finished and returning in a direction opposite to the direction indicated by arrow 72. That is, the first and second driving mechanisms 60 and 70 convey the plate 5 in one-way direction indicated by arrows 62 and 72.

As illustrated in FIG. 6D, the plate 5 conveyed to the shaping unit 2 is disposed and held at a predetermined position on the stacking stage 21 by the positioning unit 23. The stacking stage 21, pins 81 as the positioning unit 23, and claws 82 as the fixing and releasing mechanism 11 are provided. The pins 81 are formed on the upper surface of the holding portion 80 so as to engage with first to fourth fitting portions 51 to 54 of the plate 5 when the stacking stage 21 moves upward in the direction indicated by arrow 83 to thereby realize positioning of the plate 5. After that, when the stacking stage 21 moves further upward, the claws 82 engage with concave portions 55 to fix the plate 5 so that the relative position between the plate 5 and the stacking stage 21 does not change. The positioning between the stacking stage 21 and the plate 5 and the fixing of the position will be described later.

As illustrated in FIG. 6D, in the shaping unit 2, the stacking stage 21 moves in the up-down direction (indicated by arrow 84) together with the plate 5 whereby a material layer is stacked on the plate 5 and a shaping object is formed on the plate 5. When forming of the shaping object is finished, the plate 5 is moved downward in the direction indicated by arrow 85 as illustrated in FIG. 6E. After that, in FIG. 6F the fixing and releasing mechanism 11 is detached from the plate 5. After that, the plate 5 is moved in the direction indicated by arrow 72 by the second driving mechanism 70 to reach the third driving mechanism 90.

As illustrated in FIG. 6G, the third driving mechanism 90 conveys the plate 5 to the cooling unit 3. The third driving mechanism 90 has a claw 91 similarly to the second driving mechanism 70. A concave portion (not illustrated) of the plate 5 formed on the upstream side in the direction indicated by arrow 92 engages with the claw 91 and the plate 5 is conveyed in the direction indicated by arrow 92 by the third driving mechanism 90. As a result, the plate 5 reaches the cooling unit 3 as illustrated in FIG. 6H. A spring mechanism (not illustrated) is provided in the claw 91 so that the claw 91 is disengaged from the plate 5 when the third driving mechanism 90 finishes conveying of the plate 5 and returns in a direction opposite to the direction indicated by arrow 92. That is, the second and third driving mechanisms 70 and 90 convey the plate 5 in one-way direction indicated by arrows 72 and 92.

The first to third driving mechanisms 60, 70, and 90 each have a general linear actuator and a guide for guiding the plate 5. When the guide is provided, it is desirable that the height positions in the horizontal direction of the guides of the driving mechanisms 60, 70, and 90 for supporting and guiding the lower surface of the plate 5 are aligned or the height position on the downstream side in the conveying direction is slightly lower so that the plate 5 is conveyed smoothly.

As described above, since the driving mechanisms are provided in the respective positions, the plate 5 can be conveyed with a simple configuration. As a result, it is possible to decrease the size of the apparatus 4. Moreover, since the driving mechanism does not extend across each position, it is possible to secure such scalability as to connect respective positions as units. Hereinabove, the configuration of the shaping apparatus and a series of operations of the shaping apparatus when one shaping object is shaped have been described.

Next, an operation when the apparatus 4 receives a shaping instruction to perform a shaping operation continuously will be described. When the apparatus 4 receives a shaping instruction to perform a shaping operation continuously, the control unit 16 allows the shaping unit 2 to perform a shaping operation of shaping the next shaping object (hereinafter referred to as a subsequent shaping object) subsequently to a shaping operation of shaping a preceding shaping object (hereinafter referred to as a preceding shaping object).

As described above, in the present embodiment, when a plurality of shaping objects is shaped continuously, a cooling operation of the cooling unit 3 performed on the preceding shaping object and a shaping operation of the shaping unit 2 performed on the subsequent shaping object can be executed in parallel. Thus, the apparatus 4 can perform a shaping operation on a subsequent shaping object during a cooling operation on a preceding shaping object. Thus, it is possible to shorten the time required for shaping a plurality of shaping objects continuously with high accuracy. Furthermore, it is possible to secure a sufficient time for the cooling unit 3 cooling the shaping object and a shaping operation can be performed with high accuracy.

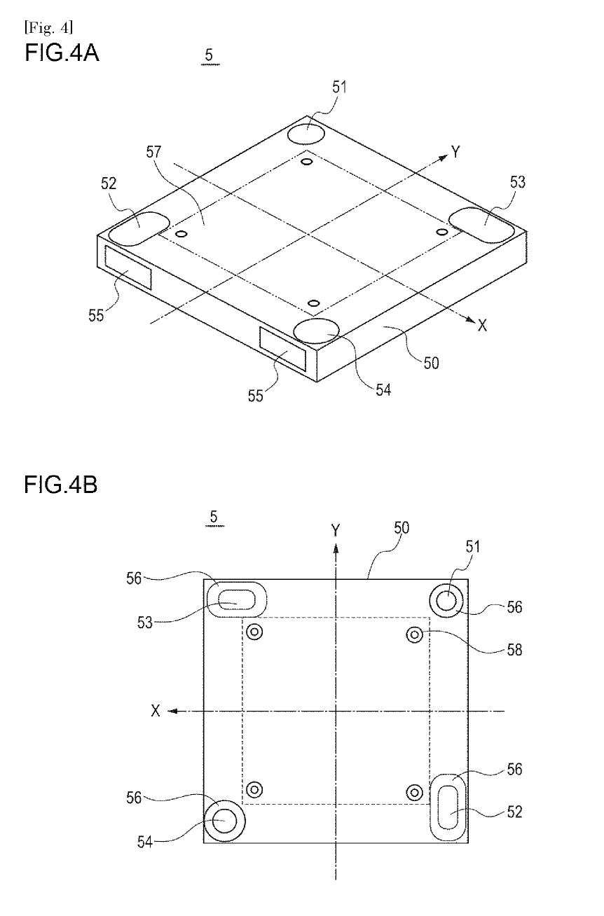

Next, the plate 5 will be described with reference to FIGS. 4A and 4B. FIG. 4A is a perspective view of the plate 5 when seen from an upper surface side (the surface side on which a shaping object has been shaped) and FIG. 4B is a plan view of the plate 5 when seen from the rear surface side (the surface side that comes into contact with the stacking stage 21).

The plate 5 has a first fitting portion 51, a second fitting portion 52, a third fitting portion 53, a fourth fitting portion 54, and a plurality of engagement portions (concave portions) 55. The first fitting portion 51, the second fitting portion 52, the third fitting portion 53, and the fourth fitting portion 54 are disposed on the four corners of the rear surface of the plate 5.

The first fitting portion 51 has a fitting hole that fits to the pin 81 of the stacking stage 21. The second fitting portion 52 has a fitting hole which is long in the x-direction and fits to the pin 81. The third fitting portion 53 has a fitting hole which is long in the y-direction and fits to the pin 81. The fourth fitting portion 54 is formed on a diagonal line extending from the first fitting portion 51 and has a fitting hole that is larger than the fitting hole of the first fitting portion 51. The fourth fitting portion 54 is configured to guide the first to third fitting portions 51 to 53 to come into contact with the corresponding pins 81 when the plate 5 is shifted from the pins 81.

In the plate 5 of the present embodiment, since the first to fourth fitting portions 51 to 54 pass through the plate 5 from the rear surface to the front surface, a material layer is stacked in a stacking region 57 on the front surface, which does not include the first to fourth fitting portions 51 to 54. However, the first to fourth fitting portions 51 to 54 may not pass through the plate. In this case, the entire front surface of the plate 5 can be used as the stacking region. Moreover, at least two fitting portions including the first fitting portion 51 serving as a reference portion and the second or third fitting portion 52 or 153 that defines a rotation direction may be provided in order to realize the positioning of the plate 5.

The engagement portions 55 are concave portions configured to engage with the claws 82 which are the fixing and releasing mechanism 11 and are formed at positions on side surfaces 50 near the four corners on the upper surface of the plate 5. When the engagement portions 55 engage with the claws 82, the relative position between the stacking stage 21 and the plate 5 can be fixed.

In FIG. 4B, a guide portion 56 which has a tapered shape toward the fitting hole is formed around each of the first to fourth fitting portions 51 to 54. The guide portions 56 guide the pins 81 to the fitting holes or the oval holes of the corresponding first to fourth fitting portions 51 to 54. The plate 5 may have table fixing portions 58 for fixing a stacking table for stacking a material layer in the stacking region 57. The stacking table may be fixed using screws or may be fixed by snapping, bonding, welding, or the like. When the stacking table is fixed, it is necessary to fix the stacking table so that the flatness of the stacking region on the surface of the stacking table does not deteriorate. Moreover, it is preferable that the stacking table is formed of the same material as the material included in the shaping material.

The positioning between the plate 5 and the plate inserting mechanism 24 can be realized by an outer shape formed by the side surfaces 50 of the plate 5. Moreover, the positioning in the in-plane direction between the plate 5 and the stacking stage 21 can be realized using the first fitting portion 51, the second fitting portion 52, and the third fitting portion 53. Furthermore, the engagement portions 55 of the plate 5 and the stacking stage 21 are used for fixing the relative position between the plate 5 and the stacking stage 21 which have been positioned.

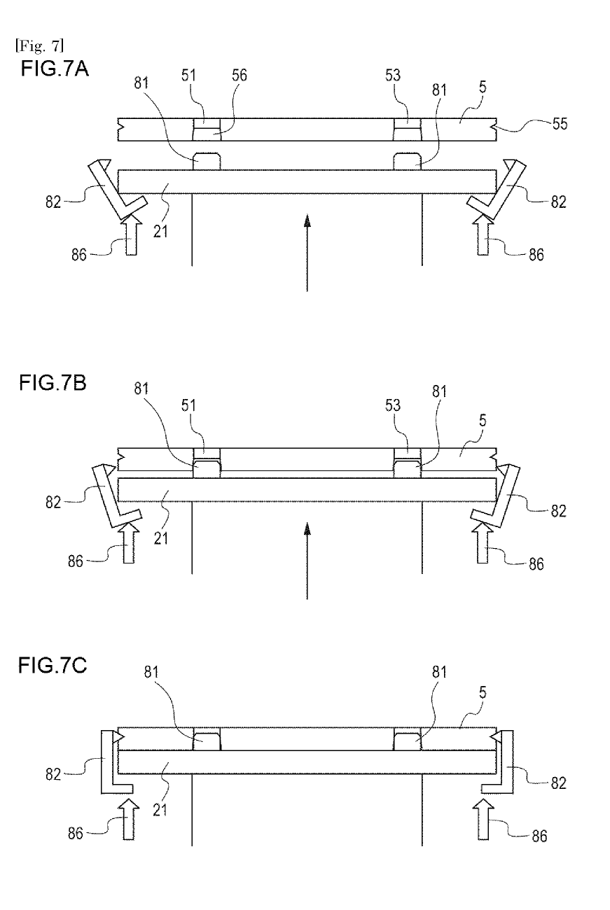

The positioning of the plate 5 in relation to the stacking stage 21 in the shaping unit 2 and the fixing of the position will be described with reference to FIGS. 7A to 7C. FIGS. 7A to 7C are side views for describing the movement of the plate 5 in the apparatus 4. As described above, the first to fourth fitting portions 51 to 54, the guide portions 56 formed in the first to fourth fitting portions 51 to 54, and the plurality of concave portions 55 that engage with the plurality of claws 82 of the stacking stage 21 are formed in the plate 5.

The stacking stage 21 has the pins 81 of which the distal ends are processed in a spherical form or chamfered and which engage with the first to fourth fitting portions 51 to 54 of the plate 5. The claws 82 as the fixing and releasing mechanism 11 are disposed on the side surfaces of the stacking stage 21. Moreover a support mechanism (not illustrated) having a spring for opening the claws 82 to put the same into a released state (that is, for unlocking the claws) is disposed. The claws 82 are disposed at positions corresponding to the concave portions 55, at the four corners of the stacking stage 21 so as to engage with the plurality of concave portions 55 when the plate 5 is disposed on the stacking stage 21. Moreover, as described above, when the claws 82 engage with the engagement portions 55, the relative position between the plate 5 and the stacking stage 21 is fixed.

FIG. 7A illustrates a state in which the plate 5 is moved to the shaping unit 2. No obstacle which can interfere with the movement of the stacking stage 21 and the plate 5 is present therebetween. When the stacking stage 21 is moved (lifted) upward, the fitting holes of the first to fourth fitting portions 51 to 54 are positioned in relation to the pins 81 while the pins 81 are guided to the guide portions 56 of the plate 5 as illustrated in FIG. 7B. When the stacking stage 21 is moved further upward, the claws 82 engage with the concave portions 55 of the plate 5 and the plate 5 is fixed to the stacking stage 21 as illustrated in FIG. 7C. In this manner, by using the fixing and releasing mechanism 11, the relative position between the stacking stage 21 and the plate 5 can be fixed to a predetermined position.

In the present embodiment, since the claws 82 engage with the concave portions 55 formed in the side surfaces 50 of the plate 5, the claws 82 are not present on the upper surface of the plate 5. Thus, the entire upper surface of the plate 5 can be used as the stacking region. Moreover, the claws 82 preferably do not protrude to the space above the upper surface of the plate 5 so that the transfer member 8 can appropriately come into contact with the stacking region of the plate 5 when the shaping unit 2 stacks a material layer.

When the stacking table is provided on the upper surface of the plate 5, the claws 82 may be present on the upper surface of the plate 5. Moreover, when the stacking table is provided on the upper surface of the plate 5, the claws 82 preferably do not protrude to the space above the upper surface of the stacking table.

The fixing and releasing mechanism 11 can fix the relative position of the plate 5 during lifting of the stacking stage 21 using the vertical driving force of the stacking stage 21 without providing a dedicated actuator and can release the fixing of the relative position when the stacking stage 21 moves downward (falls). Thus, fixing and releasing of the fixing can be realized easily with a simple configuration. When the stacking stage 21 is moved further downward, the stacking stage 21 and the plate 5 are separated subsequently to releasing of the fixing.

According to the apparatus 4 having the fixing and releasing mechanism 11, it is possible to reduce a positional shift in the in-plane direction, of a stacking position when a material layer is stacked by fixing the relative position between the plate 5 and the stacking stage 21. As a result, it is possible to stack the material layer with high accuracy and to obtain a shaping object having higher accuracy.

Moreover, conveying of the plate 5, particularly the positioning of the plate 5 in the shaping unit 2 and fixing and releasing (releasing of the fixing) of the relative position can be realized easily with a simple structure.

The fixing and releasing mechanism 11 is not limited such a mechanical fixing and releasing mechanism as described above but fixing of the position of the plate 5 in relation to the stacking stage 21 and releasing of the fixing may be realized using magnetic force, electrostatic force, negative air pressure, or the like. When the fixing and releasing mechanism 11 is configured using magnetic force, a configuration in which the plate 5 is formed using a material which is magnetically attracted and a magnet catch or the like capable of switching between a state of being magnetically attracted and a state of not being magnetically attracted is provided in the stacking stage 21 may be considered as an example. Moreover, when the fixing and releasing mechanism 11 is configured using air force, a configuration in which a plurality of holes through which air passes is formed in the surface of the stacking stage 21, and the position of the plate 5 is fixed by sucking air through the plurality of holes may be considered.

### Embodiment 5

In the present embodiment, an example of the configuration of the fixing and releasing mechanism 11 different from that of Embodiment 4 will be described. The same constituent elements as those of the above-described embodiments will be denoted by the same reference numerals, and the detailed description thereof will not be provided.

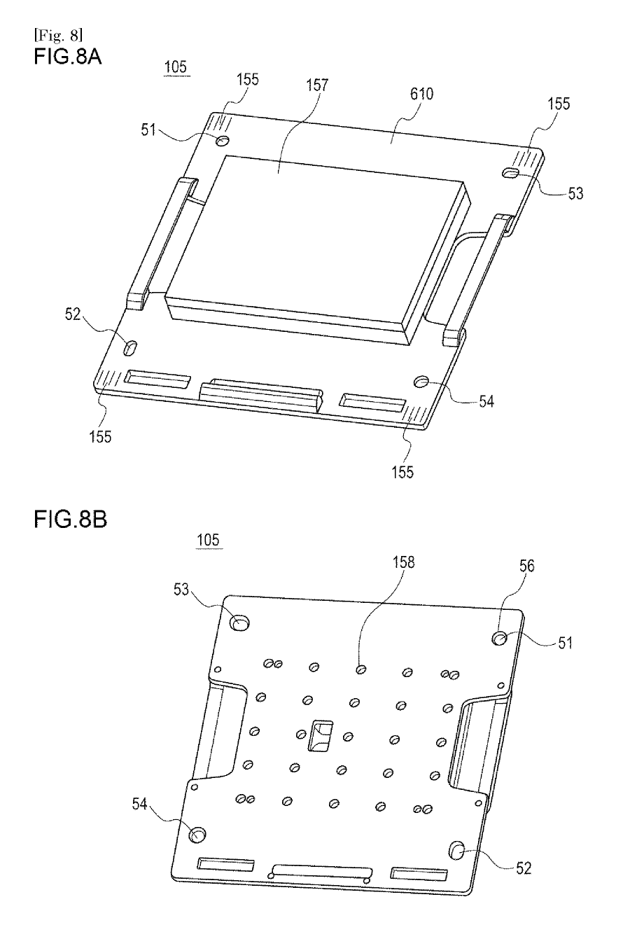

First, the configuration of the plate 105 will be described with reference to FIGS. 8A and 8B. FIG. 8A is a perspective view of the plate 105 when seen from the stacking surface side (the front surface side), and FIG. 8B is a perspective view of the plate 105 when seen from a surface side (the rear surface side) that comes into contact with the stacking stage.

The plate 105 has a planar member 610 that holds a stacking table 157, the first to fourth fitting portions 51 to 54 that fit to the plurality of fitting pins of the stacking stage 21, a plurality of engagement portions 155 (depicted as hatched portions), and the stacking table 157. The planar member 610 has a substantially square shape and a material thereof contains an aluminum alloy.

The maximum interval between the pin 81 and the outer shape of the fitting hole when the pins 81 corresponding to the first to fourth fitting portions 51 to 54 engage with the fitting holes of the first to fourth fitting portions 51 to 54 of the present embodiment is set to approximately 100 μm at most. Moreover, the first to fourth fitting portions 51 to 54 are formed near the four corners of the surface facing the stacking surface of the plate 105. The fitting holes of the first to fourth fitting portions 51 to 54 may be formed in the rear surface (the rear surface of the planar member 610) of the plate 5 and do not need to penetrate up to the front surface (the surface of the planar member 610 facing the rear surface of the plate 5) of the planar member 610. The plate 5 is positioned on the stacking stage 21 using the first to fourth fitting portions 51 to 54 and the pins 81. Moreover, at least two fitting portions including the first fitting portion 51 serving as a reference portion and the second or third fitting portion 52 or 153 that defines a rotation direction may be provided in order to realize the positioning of the plate 5.

The plurality of engagement portions 155 engages with the fixing and releasing mechanisms (fixing units) 111 of the stacking stage 21 to thereby fix the relative position between the stacking stage 21 and the plate 105. Each of the plurality of engagement portions 155 is formed at any one of the four corners of the stacking surface. In this example, each of the engagement portions 155 is a portion of the front surface of the planar member 610, and the claw 182 comes into contact with the engagement portion. A groove that fits to the claw 182 may be formed in the front surface of the planar member 610. The surface roughness of a portion of the front surface of the planar member 610 may be changed to form the engagement portion 155. The surface roughness and the configuration of the engagement portion 155 are not limited to the present embodiment.

The stacking table 157 is a table disposed on the upper surface of the plate 105, and a shaping object that contains an ABS resin as a build material is stacked on the stacking table 157. That is, the upper surface of the stacking table 157 is the stacking surface. The stacking table 157 contains an ABS resin as a material. The stacking table 157 is fixed to the planar member 610 using a fixing mechanism such as screws. When screws are used, a plurality of screw holes 158 for the planar member 610 is formed as illustrated in FIG. 8B.

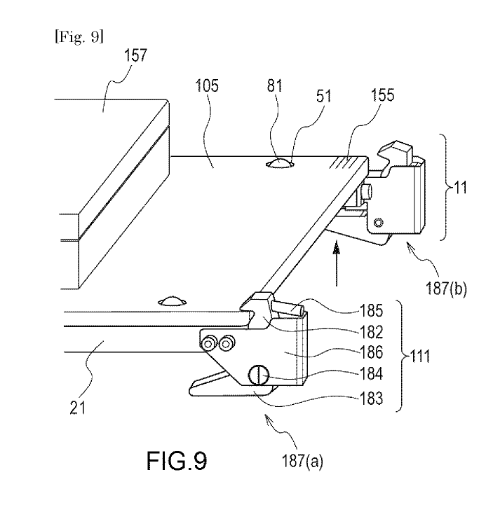

Next, the configuration of the fixing and releasing mechanism 111 will be described with reference to FIG. 9. FIG. 9 is a perspective view for describing the configuration of the fixing and releasing mechanism 111.

The relative position of the plate 105 positioned on the stacking stage 21 when the first to fourth fitting portions 51 to 54 engage with the pins 81 in relation to the stacking stage 21 is fixed by the fixing and releasing mechanism 111. The pins 81 are pins of which the distal ends have a spherical shape and which are formed on the stacking stage 21.

The fixing and releasing mechanism 111 has the claw 182, a lever 183 that rotates by interlocking with the claw 182, a rotation shaft 184 for allowing the claw 182 and the lever 183 to move in an interlocked manner, a coil spring 185, and a holder 186 that holds the rotation shaft 184.

The claw 182 engages with the engagement portion 155 to fix the relative position between the plate 105 and the stacking stage 21. The coil spring 185 is a compression coil spring that presses the claw 182 toward the positioned plate 105 to operate the claw 182. The holder 186 is fastened to the stacking stage 21 by a bolt.

The fixing and releasing mechanism 111 is configured to enter a released state (187(b)) in which the claw 182 is separated from the positioned plate 105 when an upwardly directed force is applied to an end of the lever 183 by a support mechanism (not illustrated). Moreover, the fixing and releasing mechanism 111 is configured to enter a fixed state (187(a)) in which the claw 182 approaches the positioned plate 105 to engage with the engagement portion 155 when an upwardly directed force is not applied to the lever 183 by the support mechanism (not illustrated). In this example, a state in which one of two fixing and releasing mechanisms 111 is in the released state (187(b)) and the other is in the fixed state (187(a)) is illustrated for the sake of convenience. However, it is preferable that the timings at which the plurality of fixing and releasing mechanisms 111 rotate to change the state occur substantially simultaneously.

In the present embodiment, similarly to Embodiment 4, in a state in which the stacking stage 21 has not reached a height position at which the plate 105 is positioned, the lever 183 is pressed upward and the claw 182 is in the released state (187(b)). After the stacking stage 21 is moved upward so that the plate 105 is disposed on the stacking stage 21, when the stacking stage 21 is moved further upward, the pressing of the support mechanism (not illustrated) disappears and the claw 182 engages with the engagement portion 155 to enter the fixed state (187(a)). After the shaping unit 2 finishes shaping the shaping object, when the stacking stage 21 is moved downward, the support mechanism (not illustrated) presses the lever 183 upward again and the released state (187(b)) is created again.

The plate 105 has the stacking table 157. The surface (the stacking surface) of the stacking table 157 is the highest position in the orthogonal direction, with the rear surface of the plate 105 being a reference surface. Thus, even when the engagement portion 155 is formed on the front surface of the planar member 610 of the plate 105, the fixing and releasing mechanism 111 does not interfere with the transfer member 8, the abutting portion 14, and the like during stacking. Moreover, as in Embodiment 4, the engagement portions 155 may be formed on the side surfaces of the plate 105. Furthermore, at least one of the plurality of engagement portions 155 may be formed on the side surfaces, and the other engagement portions may be formed on the front surface of the planar member 610.

With this configuration, it is possible to reduce a change in the relative position in the in-plane direction and the orthogonal direction between the plate 105 and the stacking stage 21 using the fixing and releasing mechanism 111. That is, it is possible to reduce a positional shift in the in-plane direction, of the stacking position when a material layer is stacked. As a result, it is possible to stack the material layer with high accuracy and to obtain a shaping object having higher accuracy.

It is possible to reduce a change in the relative position between the plate 5 and the stacking position during a period in which the shaping unit 2 performs shaping of a shaping object and to stack the material layer with high accuracy.

Moreover, it is possible to easily switch between the fixed state and the released state using the fixing and releasing mechanism 111 by moving the stacking stage 21 in the orthogonal direction. Furthermore, by using the first to fourth fitting portions 51 to 54 each having the guide portion 56 and the pins 81 that engage with the first to fourth fitting portions 51 to 54, it is possible to easily realize the positioning by moving the stacking stage 21 in the orthogonal direction.

While the preferred examples of the positioning unit 23 and the fixing and releasing mechanisms 11 and 111 of the present invention have been described, the present invention is not limited to these embodiments but various modifications and changes can be made within the scope of the spirit thereof.

For example, the positional relation of the plate 5 or the respective members of the plate 105, the number of respective members, and the like are not limited to those described in the embodiments. Moreover, in Embodiment 5, although it is described that the material of the plate 105 contains aluminum, the material of the plates 5 and 105 is not limited to aluminum. Moreover, in Embodiment 5, although it is described that the material of the plate 105 is an aluminum alloy, the material of the plates 5 and 105 is not limited to this but a plate formed of a magnesium alloy or various heat-resistant resins may be used.

The fixing and releasing mechanisms 11 and 111 are not limited to those described in the embodiments but may only need to fix the relative position between the plate 5 and the stacking stage 21. For example, in the above-described embodiments, although the plate 5 has the engagement portion 55 and the stacking stage 21 has the claw 82 as the fixing and releasing mechanism 11, the plate 5 may have the claw 82 and the stacking stage 21 may have the engagement portion 55. In this case, it is desirable that the claw 82 of the plate 5 does not interfere with the respective constituent elements of the shaping unit 2.

Moreover, although the fixing and releasing mechanisms 11 and 111 switch between the fixed state and the released state using the driving force of the stacking stage 21 moving in the orthogonal direction, an actuator for driving the claws 82 of the fixing and releasing mechanisms 11 and 111 may be provided. In this case, the control unit 16 detects the position of the stacking stage 21 in the orthogonal direction and operates the actuator to drive the claws 82 based on the position of the stacking stage 21.

Moreover, the positioning unit 23 and the fixing and releasing mechanisms 11 and 111 described in Embodiments 4 and 5 can be applied to the shaping apparatuses illustrated in FIGS. 2 and 3 in addition to the shaping apparatus illustrated in FIG. 1. Furthermore, the present invention is not limited to a shaping apparatus having a configuration in which the plate moves across respective units but can be applied to a shaping apparatus in which a material layer is stacked on a detachable plate to shape a shaping object.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-171072, filed on Aug. 31, 2015 and Japanese Patent Application No. 2015-171199, filed on Aug. 31, 2015 and Japanese Patent Application No. 2016-162816, filed on Aug. 23, 2016, which are hereby incorporated by reference herein in their entirety.

1. A shaping apparatus comprising:
a first moving unit that moves a base member;
a shaping unit that performs a shaping operation of disposing, heating, and melting a shaping material, based on slice data, and stacking the shaping material on a stacking surface of the base member, thereby shaping a shaping object;
a cooling unit that performs a cooling operation of cooling the shaping object shaped on the stacking surface of the base member; and
a control unit that controls the shaping operation, the cooling operation, and moving operation for the base member, wherein
the control unit implements control such that the first moving unit moves the base member, on which the shaping object has been shaped, to the cooling unit and a subsequent base member is inserted into the shaping unit when the shaping operation ends, and such that
the shaping operation of the shaping unit and the cooling operation of the cooling unit are executed in parallel.

2. The shaping apparatus according to claim 1, wherein
the shaping unit includes a first heating unit and the cooling unit has a second heating unit.

3. The shaping apparatus according to claim 2, wherein
the control unit increases a temperature of the cooling unit up to a target temperature by the second heating unit and then moves the base member, on which the shaping object has been shaped, from the shaping unit to the cooling unit by the first moving unit.

4. The shaping apparatus according to claim 3, further comprising:
a first detecting unit that detects presence of a base member in the cooling unit, wherein
after the shaping unit completes the shaping operation, and when the first detecting unit detects the absence of the base member, the control unit increases the temperature of the cooling unit up to the target temperature by the second heating unit.

5. The shaping apparatus according to claim 1, further comprising:
a first detecting unit that detects presence of a base member in the cooling unit, wherein
after the shaping unit completes the shaping operation on the shaping object, and when the first detecting unit detects presence of the base member, the control unit does not move the base member, on which the shaping object has been shaped, to the cooling unit and allows the shaping unit to perform the cooling operation on the shaping object shaped by the shaping unit.

6. The shaping apparatus according to claim 2, wherein
the shaping unit has a first heat-insulating chamber which is provided with the first heating unit and in which the shaping operation is performed,
the cooling unit has a second heat-insulating chamber which is provided with the second heating unit and in which the cooling operation is performed, and
a first opening and closing door which is closed so that the first heat-insulating chamber and the second heat-insulating chamber can communicate with each other when the first moving unit moves the base member, on which the shaping object has been shaped, is provided between the first heat-insulating chamber and the second heat-insulating chamber.

7. The shaping apparatus according to claim 6, further comprising:
a second opening and closing door provided in the second heat-insulating chamber to unload the base member, on which the shaping object has been shaped, from the second heat-insulating chamber; and
a fixing unit that fixes the second opening and closing door in a closed state when the temperature inside the second heat-insulating chamber is higher than a set temperature.

8. The shaping apparatus according to claim 1, further comprising:
a standby section in which a base member waits for being subjected to the shaping operation by the shaping unit; and
a second moving unit that moves the base member waiting in the standby section up to the shaping unit, wherein
the control unit moves the base member, on which the shaping object has been shaped, from the shaping unit by the first moving unit and then moves a subsequent base member from the standby section to the shaping unit by the second moving unit.

9. The shaping apparatus according to claim 8, further comprising:
a second detecting unit that detects presence of the base member in the shaping unit; and
a third detecting unit that detects presence of the base member in the standby section, wherein
when the shaping unit performs the shaping operation, the control unit moves the base member from the standby section to the shaping unit by the second moving unit in a case where the second detecting unit detects the absence of the base member in the shaping unit and the third detecting unit detects presence of the base member in the standby section.

10. The shaping apparatus according to claim 8, further comprising at least one of:
a base member supply unit which has a holding portion holding the base member and which supplies the base member held by the holding portion to the standby section; and
a shaping object holding unit which holds the base member, on which the shaping object has been shaped, after the cooling operation of the cooling unit ends.

11. The shaping apparatus according to claim 8, further comprising at least one of:
a base member supply unit which has a holding portion holding the base member and which supplies the base member held by the holding portion to the standby section; and
a shaping object holding unit which holds the base member, on which the shaping object has been shaped, after the cooling operation of the cooling unit ends, wherein
the at least one of the base member supply unit and the shaping object holding unit is detachably attached to a shaping apparatus body.

12. The shaping apparatus according to claim 1, further comprising:
a notification unit that issues notification of the end of the cooling operation when the cooling operation of the cooling unit ends.

13. The shaping apparatus according to claim 1, wherein
the shaping unit includes a stacking stage on which the base member is placed,
the stacking stage includes:
a positioning unit that positions the base member; and
a fixing unit that fixes a relative position between the base member and the stacking stage in an in-plane direction and an orthogonal direction of the stacking surface, with the base member being positioned in relation to the stacking stage by the positioning unit.

14. The shaping apparatus according to claim 13, wherein
when the stacking stage moves in a first direction of the orthogonal direction so that the base member is positioned in relation to the stacking stage by the positioning unit, and then the stacking stage moves further in the first direction, the fixing unit fixes the relative position, and
when the stacking stage moves in a second direction opposite to the first direction in a state in which the relative position is fixed, the fixing of the relative position is released.

15. The shaping apparatus according to claim 13, wherein
the base member has on a side surface thereof a plurality of concave portions, and
the fixing unit has a plurality of engagement portions that engage with the plurality of concave portions.

16. The shaping apparatus according to claim 13, wherein
the base member has a plurality of concave portions on the stacking surface or a front surface thereof, and
the fixing unit has a plurality of claws that engage with the plurality of concave portions.

17. The shaping apparatus according to claim 16, wherein
the plurality of claws enter a fixed state in which the relative position is fixed or a released state in which the relative position is not fixed, according to a position of the stacking stage in the orthogonal direction.

18. A shaping method of fabricating a three-dimensional shaping object, comprising:
a shaping step of disposing, heating, and melting a shaping material, based on slice data, and stacking the shaping material on a base member, thereby shaping a shaping object; and
a cooling step of cooling the shaping object shaped on the base member, wherein
when a shaping operation of shaping a subsequent shaping object is performed subsequently to a shaping operation of shaping a preceding shaping object, the cooling step performed on the preceding shaping object and the shaping step performed on the subsequent shaping object are executed in parallel.
